(19) United States
(12) Patent Application Publication
(10) Pub. No.: US 2015/0007948 A1
(43) Pub. Date: Jan. 8, 2015

(54) EXPANDABLE HEMBAR WINDOW SHADE SYSTEM

(71) Applicants: Ryan Voges, Simi Valley, CA (US); Sonny C. Voges, Simi Valley, CA (US); Ralph L. Smith, Lemon Grove, CA (US); Jay A. Vreeland, Simi Valley, CA (US)

(72) Inventors: Ryan Voges, Simi Valley, CA (US); Sonny C. Voges, Simi Valley, CA (US); Ralph L. Smith, Lemon Grove, CA (US); Jay A. Vreeland, Simi Valley, CA (US)

(21) Appl. No.: 14/304,216

(22) Filed: Jun. 13, 2014

Related U.S. Application Data
(63) Continuation-in-part of application No. 14/247,219, filed on Apr. 7, 2014.
Application No. 14/247,219 is a continuation-in-part of application No. 13/409,760, filed on Mar. 1, 2012, now abandoned.

(51) Int. Cl. E06B 9/68; E06B 9/42; E06B 9/40

(52) U.S. Cl. CPC E06B 9/68; E06B 9/40; E06B 9/42
USPC 160/310

(57) ABSTRACT

An improved Air Traffic Control Tower cab window shade system is presented, utilizing a faster motor than in prior art ATCT applications. The present invention's motor operates at 80 rpm and raises the shade material at 9.62 inches per second on a 2.3-inch diameter roller tube. This allows an average 8 foot high shade to fully raise in 10 seconds. The shade is half raised in about 5 seconds.

The improved speed is due to a system of rollers attached to an expanding hembar at the bottom end of the shade, providing constant tension to the shade and permitting the shade to be retracted safely at higher speed without risking scratching the cab window glass.

### RELATED APPLICATIONS

This application is a Continuation-In-Part application of U.S. patent application Ser. No. 14/247,219, which is currently copending, which is a Continuation-in-Part of U.S. patent application Ser. No. 13/409,760, now abandoned.

### FIELD OF THE INVENTION

This invention relates to the field of window shades for structures with sloped windows, such as air traffic control towers, and window shade systems.

### BACKGROUND OF THE INVENTION

Existing motorized window shade systems are relatively slow, inflexible, and use flawed methods of glass angle slope simulation. For example, the Federal Aviation Administration (FAA) had a requirement for a motorized shade system at the main Los Angeles International Airport (LAX) Air Traffic Control Tower (ATCT) cab in 2010. In the leading requirements, safety and performance were of great importance and existing motorized shade systems were not adequate. The present motorized window shade system serves the needs of air traffic controllers more effectively, not only at LAX, but at other ATCTs in the future.

The speed of shade operation can be critical in ATCTs. As a last resort safety measure, air traffic controllers use an emergency signal gun that emits a high powered red or green light beam to warn pilots and others of impending danger, for example runway incursion or bird strike. The signal gun is typically suspended from the cab ceiling in a manner that makes it quick and convenient for a controller to point and shoot the light beam in the direction of the intended target using one hand.

An ATCT cab window shade, per U.S. federal regulations, is very dark in tint so as to provide appropriate sun, heat, and glare protection for controllers. The light beam from a signal gun typically does not penetrate the state-of-the-art shade material; it is important to be able to raise the cab window shade quickly in emergency situations so that the light beam can be clearly seen from the outside.

### SUMMARY OF THE INVENTION

State-of-the-art window shades are raised quickly via a spring loaded roller. Prior art motorized shade systems require in excess of 30 seconds to fully raise a shade of typical height. With the present invention, a shade can be raised with one hand and the emergency signal gun can be used with other, typically in about 5 seconds.

In order to provide a safer product, the present cab window shade system utilizes a faster motor than in prior art ATCT applications as well as an expanding hembar at the bottom of the window shade. The hembar is on rollers in a wheeled carriage which are held in side track alongside both sides of the window.

The present invention's motor operates at 80 rpm and raises the shade material at 9.62 inches per second on a 2.3-inch diameter roller tube . This allows an average 8 foot high shade to fully raise in 10 seconds. The shade is half raised in about 5 seconds, allowing the signal gun light beam to shine through the exposed area of glass. The motor is also water resistant to protect against possible damage during shade cleaning. The overall shade operating speed of the present invention is comparable to a manually operated system, or exceeds it. This increased speed in turn improves ATCT cab safety.

The method for glass angle simulation in the present invention is unique and effective and distinguishes the present invention from prior art systems installed in an ATCT. It is required that a window shade system parallel the sloped glass found in virtually every ATCT cab. The glass is sloped at approximately a 15-degree angle by design to minimize distracting light reflections. Window shades must simulate this angle as closely to minimize light reflections.

Replication of the glass angle slope in the shade system prevents shade contact with the cab glass, to reduce light reflections and eliminate scratching of the shade material. Preventing glass/shade contact also reduces dirt, dust, and the transference of other impurities that further damage the shade material and impact outward visibility.

Manually operated window shades offer the capability of glass angle simulation via constant tension spring loaded rollers and a system of a pull cord attached to the bottom of the shade that routes through a locking pulley. Drawing or retracting the cord and locking it by use of a clutch driven pulley allows the shade to be stopped in any upward position. It also results in the shade being pulled taught and simulating the glass angle slope.

Such capability is not inherent in conventional motorized shade systems. A number of methods for accomplishing this have been attempted with varying results.

For example, a series of two or three ball transfers have been attached to the shade's bottom hembar. The design allows the bottom of the shade to roll against the sloped glass during operation. This method does not always prevent glass-shade contact, as the material often sags onto the glass. It also often does not offer effective simulation of the glass angle. Additionally, the ball transfers typically scratch and permanently damage the cab glass over the course of repeated contact. They are also prone to accumulating dirt, dust, and other impurities and transferring them to the glass. The effect of scratching and impurity transference also impacts outward visibility for controllers.

The present invention utilizes a weighted window shade hembar to address these issues. The hembar has a set of rollers on either end that roll within a track alongside the ATCT window. The hembar also possesses an expandable, sliding internal bar that maintains contact with the rollers on the slanted side of the window.

When mounted at a proper distance from the cab glass, the present invention's roller motor and expandable hembar keeps the shade material on a plane parallel to the glass. This helps minimize light reflections and prevents shade contact with the glass. It does so securely, reliably, and without the drawbacks of previously used methods. The shade material is pulled taught and does not contact the glass. Neither the rollers or the hembar nor any of its components contact the glass, removing the possibility of scratching or damage to the glass.

### BRIEF DESCRIPTION OF THE DRAWINGS

FIG. 1. Window shade assembly showing expandable hembar

FIG. 2. Shade fully extended

FIG. 3. Shade partially raised

### DETAILED SPECIFICATION

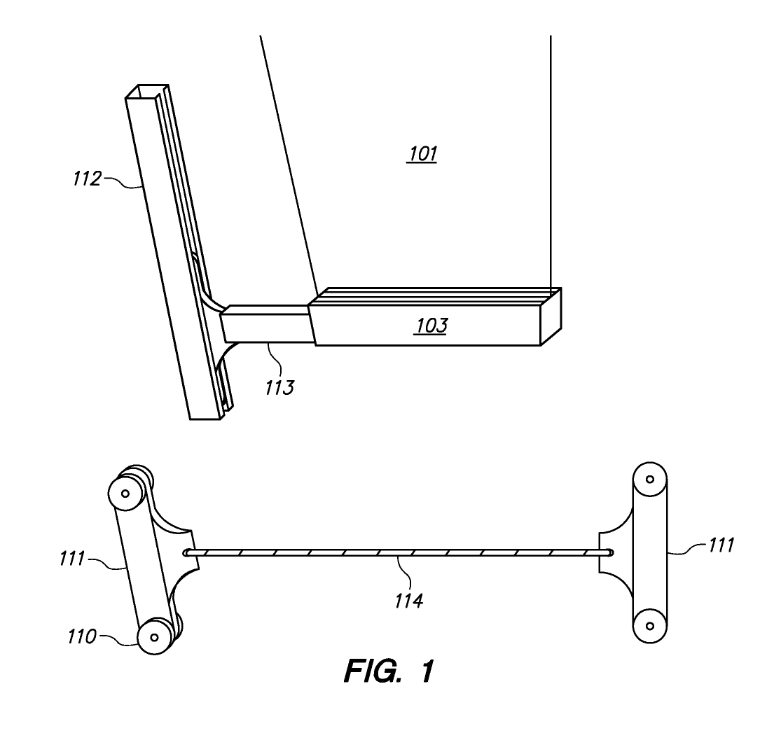

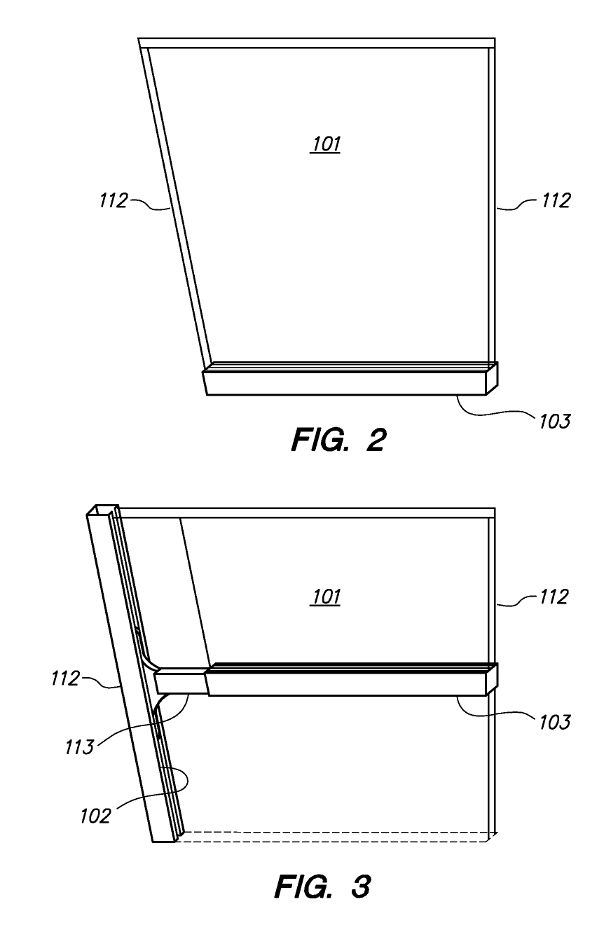

As shown in FIG. 1, the present invention's shade 101 is trapezoidally shaped with the slanted side of the shade on the left. When the shade 101 is not fully extended to cover the window, as in FIG. 3, there is a space between the edge of the shade and the window side 102. In FIG. 2, when the shade's bottom hembar 103 is drawn all the way to the bottom of the window by the weights embedded in it (not shown), the space between the edge of the shade 101 and the left window side 102 is completely covered.

The present invention maintains constant tension on the shade 101 by means of the weights in the hembar 103 and the roller wheels 110 on the wheeled carrier 111 inside the side track 112 on either side of the ATCT window, maintaining the position of the shade 101 with respect to the ATCT window glass and the sides of the ATCT window.

The shade's bottom hembar 103 is hollow and possesses a hembar extension 113 with an elastic band 114 through it, connecting the two wheeled carriers 111, as shown in FIG. 1. The elastic band 114 is at its maximum stretch when the shade 101 is at the top of the window completely retracted and at its minimum stretch when the shade 101 is fully extended and the hembar 103 is at the bottom of the window.

When mounted at a proper distance from the cab glass, the present invention keeps the shade 101 material on a plane parallel to the glass. This helps minimize light reflections and prevents shade 101 contact with the glass. The shade 101 material is pulled taught at all times by the weights inside the hembar 103 and does not contact the glass.

Previous installations of the window shade system used a spring box to pull the shade down the window and there were no guiding rollers. The present invention eliminates weight on the shade from the spring boxes and makes the shade roll down and up quieter. The absence of spring box pull down makes shades of any length possible using this system.

The present invention's motor operates at 80 rpm and raises the shade 101 material at 9.62 inches per second on a 2.3-inch diameter roller tube. This allows an average 8 foot high shade 102 to fully raise in 10 seconds. The shade 102 is half raised in 5 seconds, allowing the control tower, hand-held signal gun light beam to shine through the exposed area of glass.

Some installations will require sophisticated control options. A basic, motorized ATCT implementation of the present invention provides only simple and limited control over shade operation. There is a simple, two-button panel located at each window (not shown). Pressing one button draws the shade. Pressing the other raises it.

Oftentimes the controller must continue to depress the button until the shade reaches the desired position; releasing the button stops the shade. Depending on the location of the panel relative to an emergency signal gun, it is often impossible to depress a button and operate a signal gun simultaneously.

In some installations, such as the LAX ATCT installation, there is an elevated center platform in the ATCT cab. The FAA has had a requirement to shift shade operation to the central console. With the platform located some 15 feet from the cab windows and a total of 16 windows, each with two shades for a total of 32 shades, there was a need for centralized control.

To accommodate this requirement with an alternate embodiment, programmable group motor control boards (MCB) are incorporated into the overall system. Each MCB is hardwired using a maximum of 12 volts.

A total of 5 complex MCBs have been installed at LAX ATCT, including one master MCB. The buttons are operated by a single press of a finger. The operation mode is: pressing once initiates operation; pressing again halts it. Operations cease according to preset limits. If a button is pressed after this limit is reached, no further action will occur. For example, if a group of shades is already fully drawn, pressing the button to lower said shades would result in no further operation. It was not required to continually depress buttons until the shade reached the desired location or its limit.

Mounting locations for MCBs will be at each of the 4 corners of the center platform, with the master MCB positioned near the center. The corner MCBs offer quadrant control over shades. A user has the ability to operate the 4 shades directly in front of them as they faced the MCB.

The master MCB effectively offers group control over every shade in the cab. Utilizing 2 distinguishable columns of buttons, each with 2 sub-columns, the user could raise or lower all primary or secondary shades controlled by the other MCBs. Using these buttons, the 4 primary or 4 secondary shades at each quadrant could be raised or lowered. At the bottom of each column were 2 buttons, one each to simultaneously raise or lower every primary shade in the cab and one each to simultaneously raise or lower every secondary shade. This offered the capability to raise or lower all 32 shades in the cab with the push of just two buttons. A single button located in the lower right corner of the master MCB halted any and all ongoing operation.

In addition to the control offered by the master MCBs, the workstation located below each of the 16 windows receives a simple MCB for its 2 shades. Each is dry contact hardwired and contains 2 separate toggle switches. One is designated for control over the primary shade at the workstation. The other was for the secondary shade. Pressing in the appropriate direction raises the relevant primary or secondary shade. Pressing in the opposite direction lowers the relevant primary or secondary shade. During raising or lowering, pressing the button in the same or opposite direction would halt operation. This switch will operate the shade up or down regardless of programming or position of any other switch or control. The simple MCBs, in aggregate, offer control over every shade in the cab independently of programming so that, in the event of a programming failure with either the central MCBs, the dry contact MCBs would still operate the shade.

With the present invention, many different combinations of simple and complex MCBs, as well as various configurations thereof, are available. MCBs can be located virtually anywhere in an ATCT cab and MCB buttons can be programmed and accordingly labeled to perform nearly any shade operating function. The overall flexibility of the system offers a wide array of control configurations to users, provided proper installation. In addition, programming and button functions are changeable by those with appropriate expertise. Therefore, once an initial configuration is set, it is not necessarily permanent.

The apparatus and methods described are the preferred and alternate embodiments of this invention but other methods are possible and are within the contemplation of this patent.

What is claimed is:

1. A motorized window shade system comprised of a window shade and a motorized window shade retractor,
the window shade a flat shade made of flexible material in the shape of a trapezoid, the window shade possessing an expandable hembar at the bottom end of the shade,
the motorized retractor attached to the upper end of an air traffic control cab window, the motorized retractor attached to the top end of said window shade and capable of completely retracting said shade to the top of the air traffic control cab window, the motorized retractor operating at a rate of at least 80 rpm in order to raise the window shade at a minimum 9.62 inches per second,
the expandable hembar at the bottom end of the shade is hollow and is expandable from the width of the bottom of the trapezoidally-shaped air traffic control cab window to the width of the top of the air traffic control cab window as the window shade is drawn up the window by the window shade retractor,
The expandable hembar connected at each end to a wheeled carrier, said wheeled carriers each held within a side track along the left and right edges of said air traffic control cab window, the combination of wheeled carriers and expandable hembar maintaining an even strain on the bottom end of the shade by means of weights located within said expandable hembar,
the motorized retractor capable of retracting or releasing said window shade from said retractor in combination with the tension provided by the hembar weights, said tension keeping the window shade taut at all times such that the window shade is at a set distance from the window edges at all times.

2. The motorized window shade system of claim 1, where the expandable hembar is connect to the wheeled carriers by means of an elastic band that runs through the hollow expandable hembar and is attached to each wheeled carrier.

3. The motorized window shade system of claim 1, where the weights located within the expandable hembar are adjustable to adjust the speed at which the window shade is retracted or released.
